(19) United States
(12) Patent Application Publication
(10) Pub. No.: US 2025/0105899 A1
(43) Pub. Date: Mar. 27, 2025

(54) CSI PREDICTION USING MACHINE LEARNING

(71) Applicant: Samsung Electronics Co., Ltd., Suwon-si (KR)

(72) Inventors: Daoud Burghal, San Jose, CA (US); Andreas Molisch, Los Angeles, CA (US); Yang Li, Plano, TX (US); Yan Xin, Princeton, NJ (US)

(21) Appl. No.: 18/894,934

(22) Filed: Sep. 24, 2024

Related U.S. Application Data
(60) Provisional application No. 63/540,307, filed on Sep. 25, 2023.

(51) Int. Cl. H04B 7/06; H04W 24/10; H04W 64/00

(52) U.S. Cl. CPC H04B 7/0626; H04W 24/10; H04W 64/006

(57) ABSTRACT

A base station includes a transceiver, and a processor operatively coupled to the transceiver. The processor is configured to estimate a mobility level of a user equipment (UE), and determine whether the estimated mobility level of the UE exceeds a speed threshold. The processor is also configured to generate, from a channel response prediction model, a future channel response prediction based on the estimated mobility level of the UE and whether the estimated mobility of the UE exceeds the speed threshold.

### CROSS-REFERENCE TO RELATED APPLICATION AND CLAIM OF PRIORITY

This application claims priority under 35 U.S.C. § 119 (e) to U.S. Provisional Patent Application No. 63/540,307 filed on Sep. 25, 2023. The above-identified provisional patent application is hereby incorporated by reference in its entirety.

### TECHNICAL FIELD

This disclosure relates generally to wireless networks. More specifically, this disclosure relates to channel state information (CSI) prediction using machine learning.

### BACKGROUND

Massive multiple-input multiple-output (mMIMO) is a technology used to improve the spectral efficiency of 4G and 5G cellular networks. The number of antennas in mMIMO is typically much larger than the number of user equipments (UE), which allows a base station (BS) to perform multi-user downlink (DL) beamforming to schedule parallel data transmission on the same time-frequency resources. However, the performance of beamforming depends heavily on the quality of channel state information (CSI) at the BS. It has been recently verified that multi-user MIMO (MU-MIMO) performance degrades with UE mobility. CSI prediction can be used to combat CSI aging, thus the system can reduce the impact of processing delay and possibly the overhead. These problems are important to address especially at higher UE mobilities.

### SUMMARY

This disclosure provides apparatuses and methods for CSI prediction using machine learning.

In one embodiment, a base station (BS) is provided. The base station includes a transceiver, and a processor operatively coupled to the transceiver. The processor is configured to estimate a mobility level of a user equipment (UE), and determine whether the estimated mobility level of the UE exceeds a speed threshold. The processor is also configured to generate, from a channel response prediction model, a future channel response prediction based on the estimated mobility level of the UE and whether the estimated mobility of the UE exceeds the speed threshold.

In another embodiment, a UE is provided. The UE includes a transceiver, and a processor operatively coupled to the transceiver. The processor is configured to estimate a mobility level of the UE, and determine whether the estimated mobility level of the UE exceeds a speed threshold. The processor is also configured to generate, from a channel response prediction model, a future channel response prediction based on the estimated mobility level of the UE and whether the estimated mobility of the UE exceeds the speed threshold.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4 illustrates an example beamforming architecture according to embodiments of the present disclosure;

FIG. 5 illustrates an example structure for methods of high-speed CSI prediction according to embodiments of the present disclosure;

FIG. 6 illustrates an example procedure for CSI prediction according to embodiments of the present disclosure;

FIG. 7 illustrates an example procedure for high-speed CSI prediction according to embodiments of the present disclosure;

FIG. 8 illustrates an example of variation of pilot density according to embodiments of the present disclosure;

FIG. 9 illustrates an example procedure for upsampling of a pilot signal according to embodiments of the present disclosure;

FIG. 10 illustrates an example neural network architecture according to embodiments of the present disclosure;

FIG. 11 illustrates an example method for high-speed network training according to embodiments of the present disclosure; and

FIG. 12 illustrates an example method for high-speed CSI prediction using machine learning.

### DETAILED DESCRIPTION

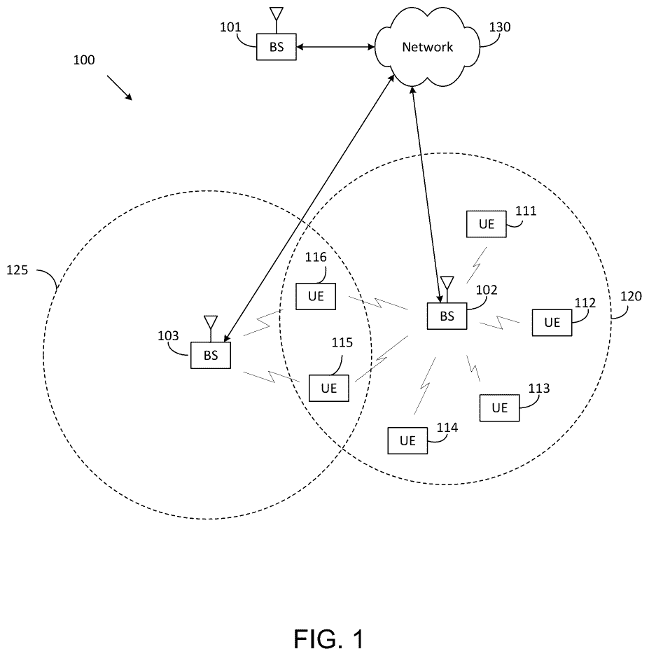

FIGS. 1 through 12, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHZ, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for high-speed CSI prediction using machine learning. In certain embodiments, one or more of the gNBs 101-103 include circuitry, programing, or a combination thereof, to support high-speed CSI prediction using machine learning in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

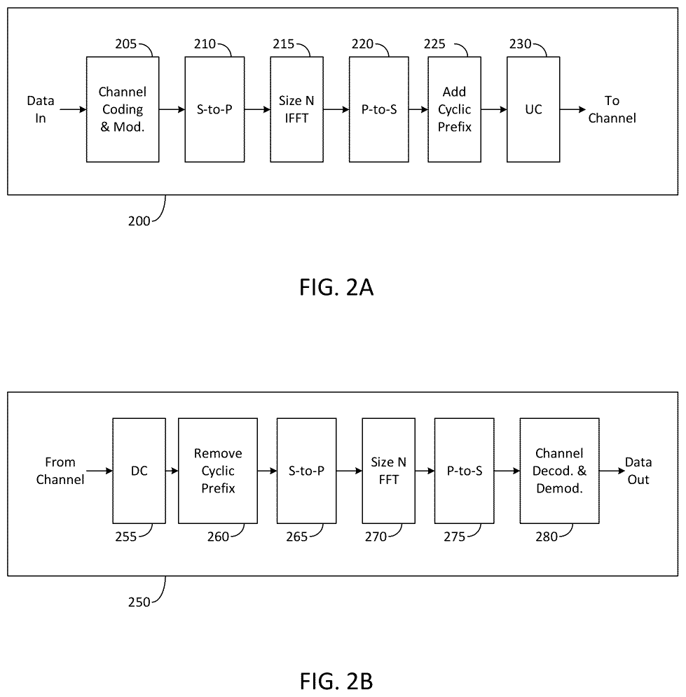

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support high-speed CSI prediction using machine learning as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

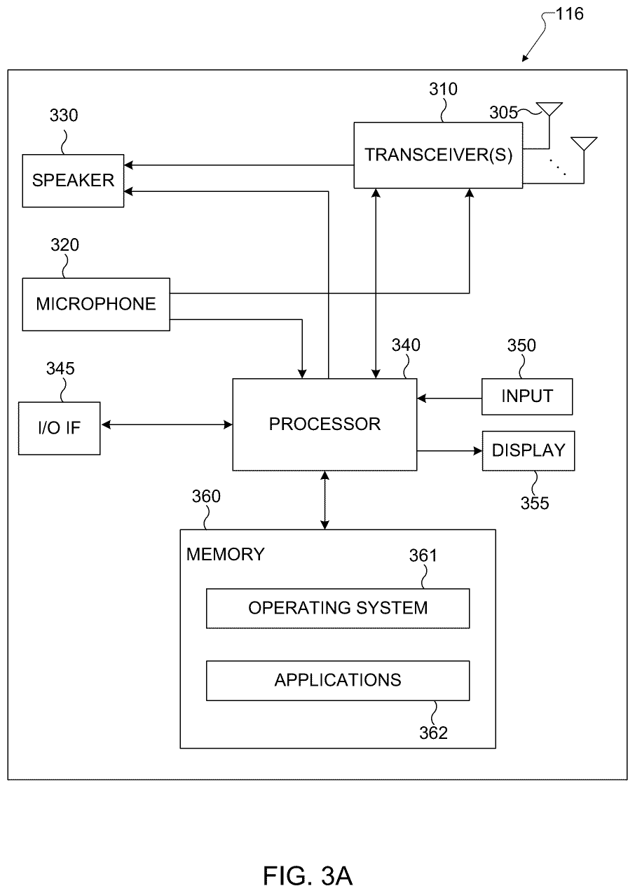

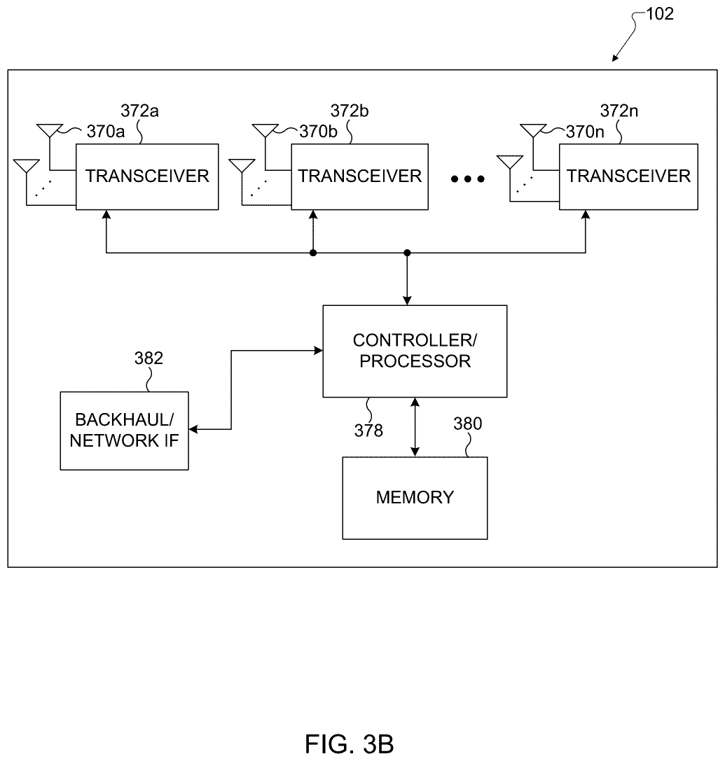

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for high-speed CSI prediction using machine learning as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support high-speed CSI prediction using machine learning as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

Release 13 of LTE supports up to 16 channel state information reference signal (CSI-RS) antenna ports which enable a gNB to be equipped with a large number of antenna elements (such as 64 or 128). In this case, a plurality of antenna elements is mapped onto one CSI-RS port. Furthermore, up to 32 CSI-RS ports are supported in Release 14 of LTE. For next generation cellular systems such as 5G, it is expected that the maximum number of CSI-RS ports will remain more or less the same.

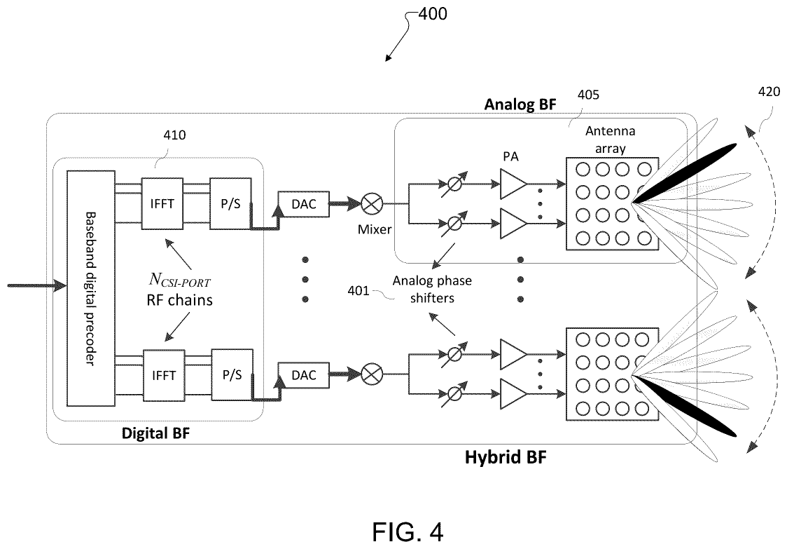

For mm Wave bands, although the number of antenna elements can be larger for a given form factor, the number of CSI-RS ports-which can correspond to the number of digitally precoded ports-tends to be limited due to hardware constraints (such as the feasibility to install a large number of ADCs/DACs at mmWave frequencies) as illustrated by beamforming architecture 400 in FIG. 4.

FIG. 4 illustrates an example beamforming architecture 400 according to embodiments of the present disclosure. The embodiment of a beamforming architecture of FIG. 4 is for illustration only. Different embodiments of a beamforming architecture could be used without departing from the scope of this disclosure.

In the example of FIG. 4, one CSI-RS port is mapped onto a large number of antenna elements which can be controlled by a bank of analog phase shifters 401. One CSI-RS port can then correspond to one sub-array which produces a narrow analog beam through analog beamforming 405. This analog beam can be configured to sweep across a wide range of angles 420 by varying the phase shifter bank across symbols or subframes or slots (wherein a subframe or a slot comprises a collection of symbols and/or can comprise a transmission time interval). The number of sub-arrays (equal to the number of RF chains) is the same as the number of CSI-RS ports N_{CSI-PORT}. A digital beamforming unit 410 performs a linear combination across N_{CSI-PORT} analog beams to further increase precoding gain. While analog beams are wideband (hence not frequency-selective), digital precoding can be varied across frequency sub-bands or resource blocks.

Although FIG. 4 illustrates an example beamforming architecture 400, various changes may be made to FIG. 4. For example, various changes to the number of antenna arrays, the number of beamforming angles, etc. may be made according to particular needs.

In MIMO systems, CSI becomes out-of-date quickly in highly dynamic environments. This is especially for massive MIMO (mMIMO) in which the BS relies on a sounding reference signal sent by a UE in the network. The UE also relies on scheduled pilot transmission (e.g., CSI-RS) by the BS. This greatly reduces the performance of mMIMO MU-MIMO transmission with mobile UEs or highly dynamic environments. Data-driven (e.g., artificial intelligence [AI] based) approaches can be utilized for CSI prediction, allowing model flexibility and applicability to the environment of interest. However, such techniques suffer from dataset bias, e.g., applicable operation speed (doppler) range can be limited to the observed speeds in the original dataset. As a result, these trained models struggle to generalize to higher speeds.

The present disclosure provides various embodiments of apparatuses and techniques to enhance the generalizability of data-driven CSI prediction in mMIMO to speeds outside the dataset range. Additionally, some embodiments to enhance the training of data-driven solutions for CSI prediction are disclosed herein.

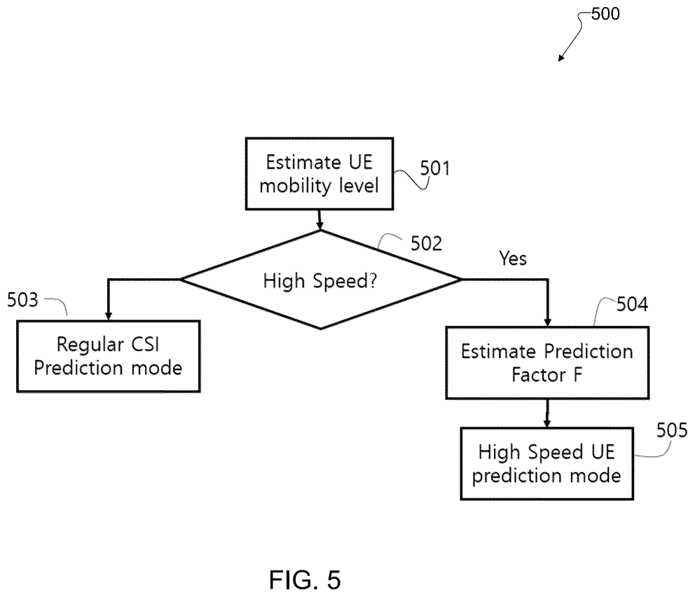

FIG. 5 illustrates an example structure 500 for methods of high-speed CSI prediction according to embodiments of the present disclosure. An embodiment of the structure illustrated in FIG. 5 is for illustration only. One or more of the components illustrated in FIG. 5 may be implemented in specialized circuitry configured to perform the noted functions or one or more of the components may be implemented by one or more processors executing instructions to perform the noted functions. Other embodiments of a structure for methods of high-speed CSI prediction could be used without departing from the scope of this disclosure.

In the example of FIG. 5, a method according to structure 500 may be performed by one or more components of a wireless network (e.g., wireless network 100 of FIG. 1). For example, in some embodiments some or all of the method may be performed by a base station, such as gNB 102 of FIG. 1. In other embodiments, some or all of the method may be performed by a user equipment, such as UE 116 of FIG. 1.

In the example of FIG. 5, the method begins at step 501. At step 501, a UE speed or effective mobility speed Vₑ is determined for a UE, such as UE 116 of FIG. 1. For example, the Vₑ of the UE can be determined based on explicit knowledge of the UE's speed (e.g., according to location information), predicted based on time-of arrival variation, localization algorithms, Doppler spread “class”, etc. In some embodiments, a base station (e.g., gNB 102) in communication with the UE may determine the Vₑ of the UE. In other embodiments, the Vₑ of the UE may be determined by the UE.

At step 502, the Vₑ of the UE is used to determine, via a CSI prediction capability (also referred to herein as a CSI predictor), whether to predict CSI (also referred to herein as a channel response prediction) based on a regular procedure or a high-speed procedure. For example, if the Vₑ of the UE is “high-speed” (for instance, if the Vₑ of the UE exceeds a threshold), it may be determined to predict the CSI based on the high-speed procedure. In some embodiments, a base station (e.g., gNB 102) in communication with the UE may have the CSI prediction capability. In other embodiments, the UE may have the CSI prediction capability. If a determination is made to predict CSI based on the regular CSI procedure, the method continues as step 503. Otherwise, the method continues at step 504.

In some embodiments a core predictor of the CSI prediction capability may be a neural network that is trained on a certain dataset. The core predictor may also be referred to as a channel response prediction model. Based on the neural network, the CSI predictor can have the following attributes:
Minimum prediction speed Vₘᵢₙ such as speed in km/h, Doppler spread in Hz, or some other metric that capture correlation,
Maximum prediction speed Vₘₐₓ such as speed in km/h, Doppler spread in Hz, or some other metric that capture correlation,
Prediction complexity metric C₀, e.g., number of Floating-Point Operations.

In some embodiments, for a given Vₑ of the UE and the standard deviation σₑ of the Vₑ: if Vₑ<Vₘₐₓ and

$${σ}_{e} \leq \frac{{V}_{max} - {V}_{min}}{2}$$

a regular CSI prediction procedure is used. Otherwise, a high-speed CSI prediction procedure is used.

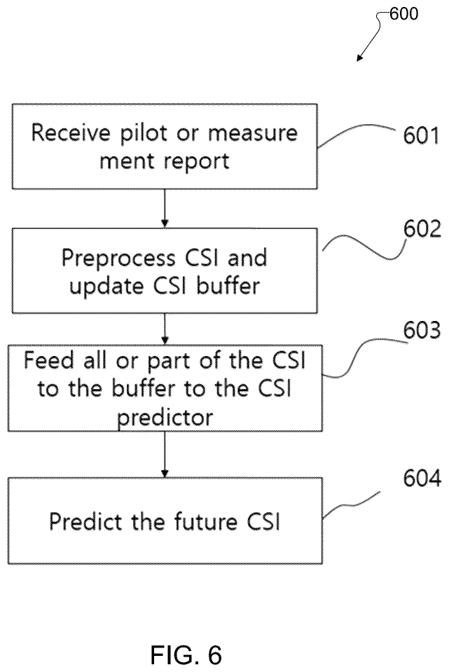

At step 503, a CSI prediction is made according to a regular procedure of the CSI prediction capability. For example, the CSI prediction may be made according to procedure 600 of FIG. 6.

At step 504, a prediction factor F is estimated by the CSI prediction capability for use in a high-speed procedure of the CSI prediction capability.

In some embodiments, for the high-speed CSI prediction procedure, the average prediction speed may be calculated as

$${V}_{m} = \frac{{V}_{max} + {V}_{min}}{2}$$

In some embodiments, F, may be calculated as follows:
Identify

$$x ∈ [ \frac{{V}_{min} - {V}_{max}}{2} , \frac{{V}_{max} - {V}_{min}}{2} ] to get F = \frac{{V}_{e}}{{V}_{m} + x} ,$$

such that F∈{2, 3, . . . }, while having

$$\frac{{σ}_{e}}{F} \leq \frac{{V}_{max} - {V}_{min}}{2} .$$

To identify x, other factors can be considered, such as the availability of signal upsampling options or the overall complexity C_{A}. For example, in some embodiments x can scale with the factor F, e.g., C_{A}=F C₀. In such embodiments, a smaller F may be utilized. Alternative restrictions to F based on Vₘ and σₑ are possible, e.g.,

$$[ \frac{{V}_{m} - {σ}_{e}}{F} , \frac{{V}_{m} + {σ}_{e}}{F} ]$$

are set such that they are within [Vₘᵢₙ, Vₘₐₓ] depending on the identified core predictor capabilities.

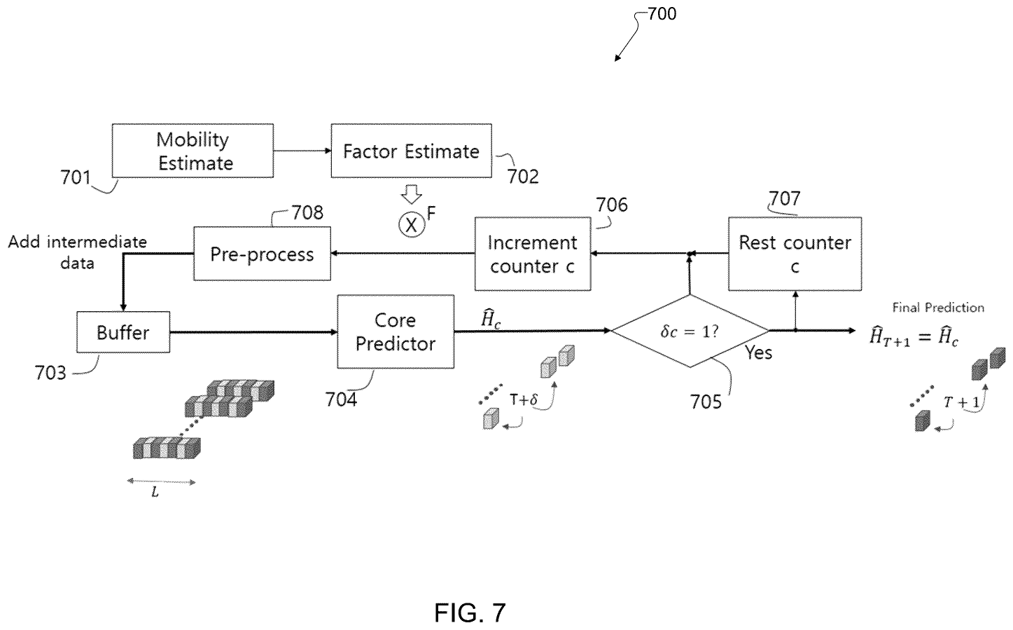

At step 505, a CSI prediction is made by the CSI prediction capability, based on F, according to the high-speed procedure of the CSI prediction capability. For example, the CSI prediction may be made according to procedure 700 of FIG. 7.

Although FIG. 5 illustrates one example structure 500 for methods of high-speed CSI prediction, various changes may be made to FIG. 5. For example, while shown as a series of steps, various steps in FIG. 5 could overlap, occur in parallel, occur in a different order, occur any number of times, be omitted, or replaced by other steps.

FIG. 6 illustrates an example procedure for CSI prediction 600 according to embodiments of the present disclosure. An embodiment of the procedure illustrated in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments of a procedure for CSI prediction could be used without departing from the scope of this disclosure.

In the example of FIG. 6, procedure 600 begins at step 601. At step 601, a BS (e.g., gNB 102) or the UE of FIG. 5 (e.g., UE 116) receives CSI information (e.g., a CSI pilot or measurement report) at time T₀. For example, at time T₀ gNB 102 may receive an SRS or other CSI measurement report from UE 116, or UE 116 may receive a CSI-RS from gNB 102.

In some embodiments, procedure 600 includes a CSI buffer, a parameter estimation module, and a channel prediction module (e.g., the CSI predictor of FIG. 5). The CSI buffer stores past uplink channel estimates. At step 602, the parameter estimation module updates the CSI buffer with updated parameters by preprocessing the CSI information and storing the preprocessed CSI information in the CSI buffer. The updated parameters are used to derive the future channel response.

At step 603, the parameter estimation module feeds the CSI predictor with some or all of the parameters in the updated CSI buffer.

At step 604, the channel prediction module predicts a future channel response based on the parameters in the updated CSI buffer.

Although FIG. 6 illustrates one example procedure for CSI prediction 600, various changes may be made to FIG. 6. For example, while shown as a series of steps, various steps in FIG. 6 could overlap, occur in parallel, occur in a different order, occur any number of times, be omitted, or replaced by other steps.

FIG. 7 illustrates an example procedure for high-speed CSI prediction 700 according to embodiments of the present disclosure. An embodiment of the method illustrated in FIG. 7 is for illustration only. One or more of the components illustrated in FIG. 7 may be implemented in specialized circuitry configured to perform the noted functions or one or more of the components may be implemented by one or more processors executing instructions to perform the noted functions. Other embodiments of a procedure for high-speed CSI prediction could be used without departing from the scope of this disclosure.

In the example of FIG. 7, procedure 700 begins at step 701. At step 701, the mobility of a UE is estimated, in some embodiments, similar as described regarding steps 501 and 502 of FIG. 5.

At step 702, a prediction factor F is estimated, in some embodiments, similar as described regarding step 504 of FIG. 5.

In the example of FIG. 7, for a given F, the time resolution δ=1/F is defined. At step 703, the channel observation at time T, is entered into the CSI buffer. The channel observation may be based on, for example, a pilot or measurement report. The pilot or measurement report may be an initial pilot or measurement report received before beginning procedure 700, or a subsequent pilot or measurement report received during procedure 700.

At step 704, to predict the channel state at T+1, given the channel observation at T, the data in the CSI buffer is used to predict the channel state at T+c δ, where c is a counter that starts at value=0.

At step 705, if δ*c=1, the counter c is reset at step 707 and the predicted channel is the latest output of the core predictor. Otherwise, the counter is incremented at step 706.

At step 708, the predicted channel at T+c δ is added to the buffer after pre-processing.

Although FIG. 7 illustrates one example procedure for high-speed CSI prediction 700, various changes may be made to FIG. 7. For example, while shown as a series of steps, various steps in FIG. 7 could overlap, occur in parallel, occur in a different order, occur any number of times, be omitted, or replaced by other steps.

In the example of FIG. 7, in many cases, the available historic data in the buffer can indicate the signal variation speed. Subsampling the data or omitting the pilot signal can indicate or mimic fast channel variations, and thus high mobility. In some embodiments, to use a pretrained model at lower speeds, the signal in the buffer is upsampled. Upsampling of the signal can be achieved by temporarily allocating a higher pilot density and/or employing upsampling techniques.

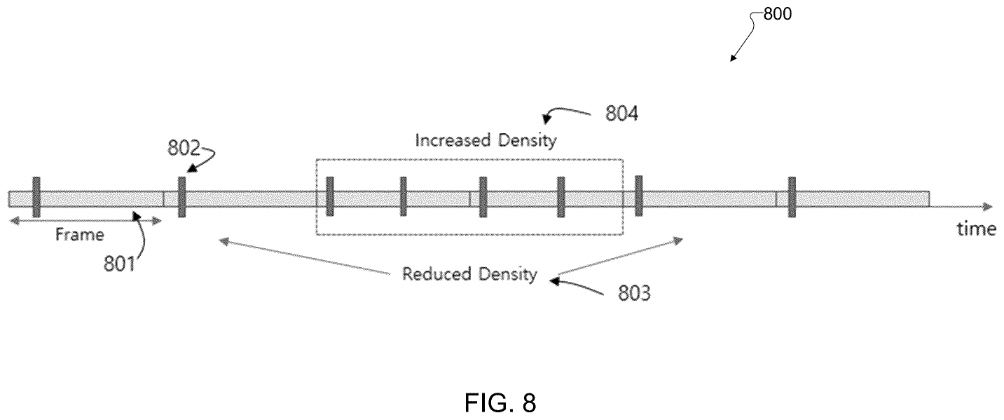

For example, as shown in FIG. 8, the periodicity of the pilot can be temporarily increased proportional to the factor F. Once the initial buffer is filled, the periodicity can be reduced back.

FIG. 8 illustrates an example of variation of pilot density 800 according to embodiments of the present disclosure. The embodiment of variation of pilot density of FIG. 8 is for illustration only. Different embodiments of variation of pilot density could be used without departing from the scope of this disclosure.

In the example of FIG. 8, initially, one pilot (802) per frame (801) is configured. After the second frame, an increased pilot density is configured (804), with twice the pilot density (by factor F=2), before it reduces back to the original density (803).

Although FIG. 8 illustrates an example of variation of pilot density 800, various changes may be made to FIG. 8. For example, various changes to the increase in density, the time of the density increase, etc. may be made according to particular needs.

In some embodiments, where the CSI prediction is based on SRS, a change in SRS periodicity can be indicated by a change of the SRS resources and resource type. In some embodiments, the change can be with allocation of additional aperiodic SRS or semi-persistent SRS with appropriate periodicity AndOffset values such that the overall SRS satisfies the factor F. In other embodiments, for prediction based on other pilots (e.g., CSI-RS), a modification of configuration and/or addition of resources can also be applied to the pilot to satisfy the needed pilot density. In some embodiments, to avoid RRC reconfiguration procedure, multiple resource sets can be assigned beforehand, e.g., a semi-persistent SRS and an aperiodic SRS. In other embodiments, a periodic SRS with nominal SRS periodicity and an aperiodic SRS can be used. In some embodiments, during the increased density, the aperiodic SRS can be triggered as needed with PDCCH DL DCI. In some embodiments, if semi-persistent SRS is used, the trigger can be with a MAC-CE. In some embodiments, a different combination of the above can also be used.

In some embodiments, for CSI-RS, the periodicity can also set the appropriate periodicity AndOffset in the NZP-CSI-RS-Resource IE. Given that different resource sets can be configured (e.g., a combination of periodic, aperiodic or semi-persistent), signaling to the UE may be used to trigger or switch on or off the aperiodic and semi-persistent ones.

Long sequential prediction is prone to error propagation. In some embodiments, after the initial phase, the pilot density increase, and decrease can be scheduled or decided based on the prediction performance. The decision to increase the density can be made based on variation of error metrics (e.g., IIR filtered Normalized Mean Square Error, (NMSE)). For example, let Et be the prediction error (e.g., NMSE) at time t.

$${\overline{E}}_{t} = ( 1 - λ ) {\overline{E}}_{t - 1} + λ {E}_{t}$$

Where λ∈(0,1]. Let the density reduction be at t_{d}, define a period Tₒ to add the stability of the error metric after density decrease. Then, a decision to increase the density can be made if error increases beyond initial values, e.g., Ēₜ_{_{d}}_{+T}_{ₒ}+β<Ēₜ for time t>t_{d}+Tₒ, where β is a design tolerance threshold.

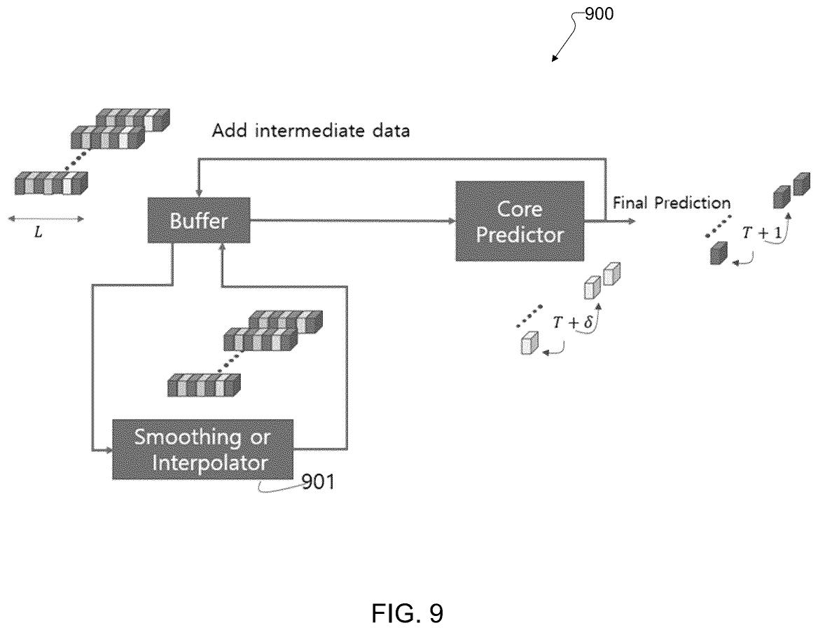

As previously described, upsampling of the pilot signal may be achieved by utilizing upsampling techniques. For example, the pilot signal may be upsampled as shown in FIG. 9.

FIG. 9 illustrates an example procedure for upsampling of a pilot signal 900 according to embodiments of the present disclosure. An embodiment of the procedure illustrated in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments for upsampling of a pilot signal could be used without departing from the scope of this disclosure.

The procedure of FIG. 9 is performed at step 901, which may occur, for example, during the process of FIG. 7, after step 703 and prior to step 704. Other steps shown in FIG. 9 may be performed, in some embodiments, substantially similar as described regarding FIG. 7.

In the example of FIG. 9, with a factor F (e.g., as determined in step 702 of FIG. 7), at step 901, the received signal is separated by F−1 and an interpolator or smoothing process. Step 901 can be applied to a predicted signal along with the received one. The smoothing or interpolator process can be based on denoising procedures, weighted running average, polynomial, etc. The smoothing or interpolator process can also be implemented using machine learning.

In one embodiment, the interpolation can be applied to the channel coefficients in the transformed domain, e.g., delay domain. For example, let γₜᵢ be the coefficient of the signal at the i^{th} delay bin at time t. Then one can apply

$${γ}_{t + δ} ( i ) = INT ( {γ}_{t} ( i ) , {γ}_{t + 1} ( i ) , δ , A )$$

The INT function could be a linear or any other interpolation method. In this example, A is side information that can be used to enhance the interpolations, such as coefficients of neighbor delay bins.

In another embodiment, the interpolator (or smoother) can be replaced or attached to an upsampling process that can be based on a machine learning solution such as a neural network. In such an embodiment, C_{A} can be recalculated to combine the complexity needed in the added process along with Cₒ. One interpolation technique that may be utilized is to use super-resolution algorithms that are trained to produce increased signal density (by factor F).

Although FIG. 9 illustrates one example procedure for upsampling of a pilot signal 900, various changes may be made to FIG. 9. For example, while shown as a series of steps, various steps in FIG. 9 could overlap, occur in parallel, occur in a different order, occur any number of times, be omitted, or replaced by other steps.

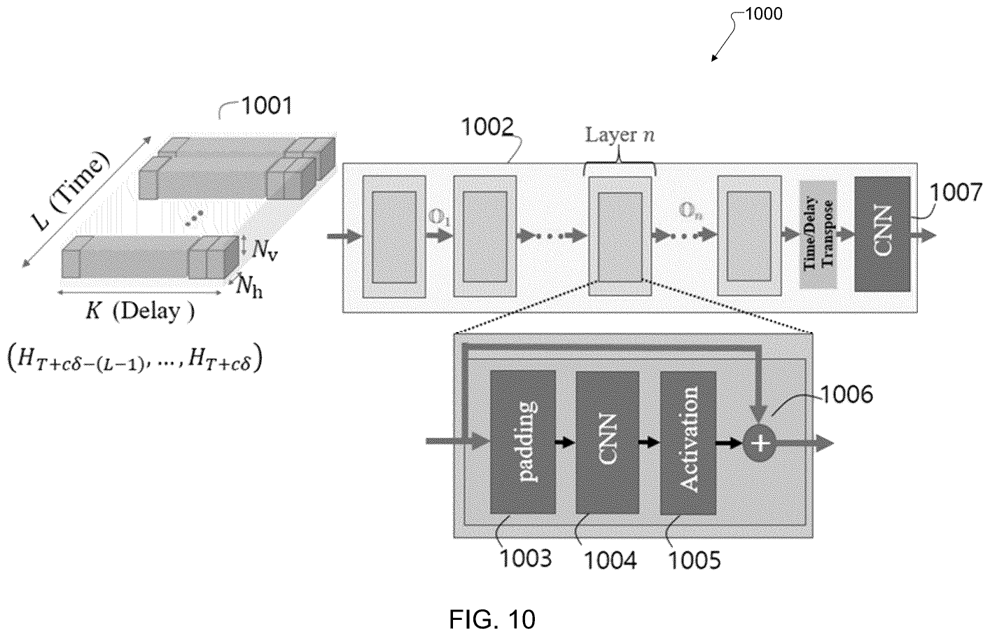

In some embodiments, to enable multi-step prediction, a lightweight core predictor is used. This can be achieved with small neural network architectures accompanied with possible skip connections or residual blocks to increase the robustness. FIG. 10 shows an example of such a network that also uses convolutional layers.

FIG. 10 illustrates an example neural network architecture 1000 according to embodiments of the present disclosure. The embodiment of a neural network of FIG. 10 is for illustration only. Different embodiments of a neural network could be used without departing from the scope of this disclosure.

The example of FIG. 10, shows processed channels 1001 in the angle delay domain, where the received channel and the predicted channel(s) are stacked into L convolutional neural network (CNN) channels and use K delay taps. The network 1002 has multiple layers, each layer comprises possible padding 1003, CNN layer 1004, activation layer (e.g., tanh or ReLU) 1005, and a skip connection (here a residual) 1006.

Although FIG. 10 illustrates an example of a neural network architecture 1000, various changes may be made to FIG. 10. For example, various changes to the number or layers, the number of channels, etc. may be made according to particular needs.

While FIG. 10 illustrates a particular embodiment of a neural network architecture, alternative structures may be utilized. For example, some embodiments may employ the solutions described in U.S. patent application Ser. No. 18/181,447 filed Mar. 9, 2023, which is incorporated by reference herein, where the core prediction can use modular implementation to speed the operation, and where the pre-calculation of the prediction at each layer can be used. In another embodiment, adaptive weights (i.e., an attention mechanism) can be used. Other procedures and transformations can also be used, such as operating in the antenna and/or frequency domain.

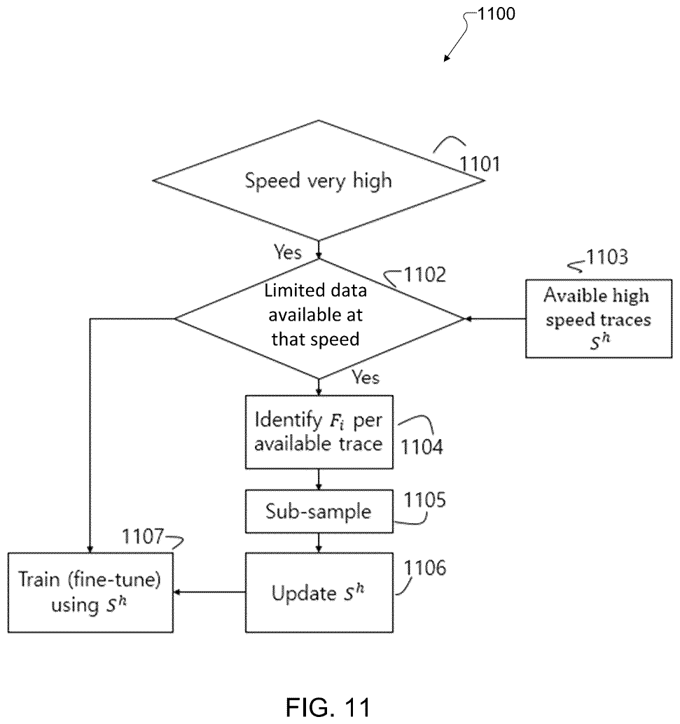

In some circumstances, such as very high speeds, C_{A}>Cₘₐₓ, or the incurred delay for prediction at T+1 is larger than the permissible delay. To compensate for these circumstances, in some embodiments, low speed dataset sets are used to train a dedicated very high-speed machine learning solution for high-speed prediction. An example is shown in FIG. 11.

FIG. 11 illustrates an example method for high-speed network training 1100 according to embodiments of the present disclosure. An embodiment of the method illustrated in FIG. 11 is for illustration only. One or more of the components illustrated in FIG. 11 may be implemented in specialized circuitry configured to perform the noted functions or one or more of the components may be implemented by one or more processors executing instructions to perform the noted functions. Other embodiments for a method of high-speed network training could be used without departing from the scope of this disclosure.

In the example of FIG. 11, method 1100 begins at step 1101. In some embodiments, method 1100 may be performed for example, by a BS (e.g., gNB 102 of FIG. 1) or a UE (e.g., UE 116 of FIG. 1). At step 1101, a determination is made whether a speed of a UE (e.g., UE 116), is a very high speed. For example, if the complexity or incurred delay for a prediction at T+1 is exceeded, this may indicate very high speed. If the speed is very high, a high-speed network can be trained beginning at step 1102. In some embodiments, the training may be offline training.

At step 1102, a determination is made whether limited data for the determined UE speed is available from a dataset (1103) of high-speed traces S^{h}. The data available for the determined UE speed is not limited, the method proceeds at step 1107. Otherwise, to avoid overfitting, the dataset S^{h} is enhanced beginning at step 1104. Diversity of the data can be determined based on the user or location that the data traces were captured for a target high speed Vₕ.

In one embodiment, at step 1104, to acquire high speed data from low speed data, for every available trace Sᵢ, where Vᵢ, σᵢ are the associated speed (or doppler class) and standard deviation respectively for the trace, a down-sampling factor Fᵢ is defined

$${\tilde{F}}_{i} = \frac{{V}_{h}}{{V}_{i}} , {F}_{i} = round ( {\tilde{F}}_{i} ) ∈ \{ 1 , 2 , 3 … \} .$$

In another embodiment,

$${F}_{i} = \frac{{V}_{h}}{{V}_{i} + {x}_{i}} , {x}_{i} ∈ [ - {σ}_{i} , {σ}_{i} ] ,$$

such that

$${F}_{i} = \frac{{V}_{h}}{{V}_{i} + {x}_{i}} ∈ \{ 1 , 2 , 3 … \} .$$

Once Fᵢ is defined, at step 1105 lower-speed data from S^{h} is down-sampled according to Sᵢ^{u}=S(1:Fᵢ:end).

At step 1106, the traces S^{h} are updated based on the down-sampled lower-speed data.

At step 1107 all the traces S^{h} are used to train the machine learning (or fine-tune the weights of the core) for the CSI prediction network (e.g., the network illustrated in neural network architecture 1000). In some embodiments, a future CSI prediction for the UE is made after the CSI prediction network is trained at step 1107.

Although FIG. 11 illustrates one example method for high-speed network training 1100, various changes may be made to FIG. 11. For example, while shown as a series of steps, various steps in FIG. 11 could overlap, occur in parallel, occur in a different order, occur any number of times, be omitted, or replaced by other steps.

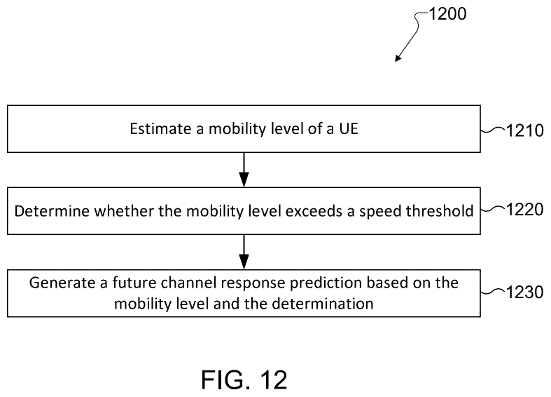

FIG. 12 illustrates an example method for high-speed CSI prediction using machine learning 1200 according to embodiments of the present disclosure. An embodiment of the method illustrated in FIG. 12 is for illustration only. One or more of the components illustrated in FIG. 12 may be implemented in specialized circuitry configured to perform the noted functions or one or more of the components may be implemented by one or more processors executing instructions to perform the noted functions. Other embodiments of a method for high-speed CSI prediction using machine learning could be used without departing from the scope of this disclosure.

In the example of FIG. 12, method 1200 begins at step 1210. In some embodiments, method 1200 may be performed for example, by a BS (e.g., gNB 102 of FIG. 1) or a UE (e.g., UE 116 of FIG. 1). At step 1210, A BS or UE estimates the mobility level of a UE. For example, if the method is performed by a UE, the UE estimates its own mobility level.

At step 1220, the BS or UE determines whether the estimated mobility level of the UE exceeds a speed threshold.

At step 1230, the BS or UE generates, from a channel response prediction model, a future channel response prediction based on the estimated mobility level of the UE and whether the estimated mobility of the UE exceeds the speed threshold.

In some embodiments, the BS or UE is configured to receive a pilot or measurement report. For example, if the method is performed by a BS, the BS may receive the pilot or measurement report from the UE. If the method is performed by a UE, the UE may receive the pilot or measurement report from a BS.

In some embodiments, if the BS or UE determines that the mobility level of the UE does not exceed the speed threshold, the BS or UE preprocesses, based on the pilot or measurement report, CSI, and updates a buffer with the preprocessed CSI. In some embodiments, the future channel response is generated by a channel response prediction model based on at least a port of information stored within the CSI buffer.

In some embodiments, if the BS or UE determines that the mobility of the UE exceeds the speed threshold, the BS or UE estimates a prediction factor. In some embodiments, the future channel response prediction is generated by the channel response prediction model based on the prediction factor.

In some embodiments, the prediction factor is estimated based on a speed of the UE and a variance of the speed of the UE.

In some embodiments, a pilot density is temporarily increased, based on the estimated prediction factor.

In some embodiments, for a number of iterations, the BS or UE generates, with the channel response prediction model, an intermediate channel state prediction based on a pilot or measurement report most recently received by the transceiver, and updates a CSI buffer with the intermediate channel state prediction. In some embodiments, the future channel response prediction is generated by the channel response prediction model based on at least a portion of the information stored within the CSI buffer after the number of iterations. In some embodiments, the number of iterations is based on the estimated prediction factor.

In some embodiments, the intermediate channel state prediction is an interpolation based on the pilot or measurement report most recently received by the transceiver and the estimated prediction factor.

In some embodiments, the BS or UE receives, during the number of iterations, at least one subsequent pilot or measurement report, and updates the CSI buffer based on the at least one subsequent pilot or measurement report.

In some embodiments, if the mobility of the UE exceeds the speed threshold, the BS or UE determines whether high-speed data is limited in a used data set or an available data set. In some embodiments, the future channel response prediction is generated based on whether the high-speed data is limited in the used data set or the available data set.

In some embodiments, if the high-speed data is limited in the used data set or the available data set, the BS or the UE down-samples lower-speed data within the used data set or the available data set, and updates a data set based on the down-sampled lower-speed data. In some embodiments, the future channel response prediction is generated based on the updated data set.

Although FIG. 12 illustrates one example method for high-speed CSI prediction using machine learning 1200, various changes may be made to FIG. 12. For example, while shown as a series of steps, various steps in FIG. 12 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A base station (BS) comprising:
a transceiver; and
a processor operatively coupled to the transceiver, the processor configured to:
estimate a mobility level of a user equipment (UE);
determine whether the estimated mobility level of the UE exceeds a speed threshold; and
generate, from a channel response prediction model, a future channel response prediction based on the estimated mobility level of the UE and whether the estimated mobility of the UE exceeds the speed threshold.

2. The BS of claim 1, wherein:
the transceiver is configured to receive, from the UE, a pilot or measurement report; and
to generate the future channel response prediction, the processor is further configured to, in response to a determination that the mobility level of the UE does not exceed the speed threshold:
preprocess, based on the pilot or measurement report, channel state information (CSI); and
update a CSI buffer with the preprocessed CSI,
wherein the future channel response prediction is generated by the channel response prediction model based on at least a portion of information stored within the CSI buffer.

3. The BS of claim 1, wherein:
the processor is further configured to, in response to a determination that the mobility level of the UE exceeds the speed threshold, estimate a prediction factor; and
the future channel response prediction is generated by the channel response prediction model based on the prediction factor.

4. The BS of claim 3, wherein the prediction factor is estimated based on a speed of the UE and a variance of the speed of the UE.

5. The BS of claim 3, wherein a pilot density is temporarily increased, based on the estimated prediction factor.

6. The BS of claim 3, wherein:
the transceiver is configured to receive, from the UE, an initial pilot or measurement report;
to generate the future channel response prediction, the processor is further configured to, for a number of iterations:
generate, with the channel response prediction model, an intermediate channel state prediction based on a pilot or measurement report most recently received by the transceiver; and
update a CSI buffer with the intermediate channel state prediction;
the number of iterations is based on the estimated prediction factor; and
the future channel response prediction is generated by the channel response prediction model based on at least a portion of information stored within the CSI buffer after the number of iterations.

7. The BS of claim 6, wherein the intermediate channel state prediction is an interpolation based on the pilot or measurement report most recently received by the transceiver and the estimated prediction factor.

8. The BS of claim 6, wherein:
the transceiver is further configured to receive, during the number of iterations, at least one subsequent pilot or measurement report; and
the processor is further configured to update the CSI buffer based on the at least one subsequent pilot or measurement report.

9. The BS of claim 1, wherein:
the processor is further configured to, in response to a determination that the mobility level of the UE exceeds the speed threshold, determine whether high-speed data is limited in a used data set or an available data set; and
the future channel response prediction is generated based on whether the high-speed data is limited in the used data set or the available data set.

10. The BS of claim 9, wherein:
to generate the future channel response prediction, the processor is further configured to, in response to a determination that the high-speed data is limited in the used data set or the available data set:
down-sample lower-speed data within the used data set or the available data set; and
update a data set based on the down-sampled lower-speed data, and
the future channel response prediction is generated based on the updated data set.

11. A user equipment (UE) comprising:
a transceiver; and
a processor operatively coupled to the transceiver, the processor configured to:
estimate a mobility level of the UE;
determine whether the estimated mobility level of the UE exceeds a speed threshold; and
generate, from a channel response prediction model, a future channel response prediction based on the estimated mobility level of the UE and whether the estimated mobility of the UE exceeds the speed threshold.

12. The UE of claim 11, wherein:
the transceiver is configured to receive, from a base station (BS), a pilot or measurement report; and
to generate the future channel response prediction, the processor is further configured to, in response to a determination that the mobility level of the UE does not exceed the speed threshold:
preprocess, based on the pilot or measurement report, channel state information (CSI); and
update a CSI buffer with the preprocessed CSI,
wherein the future channel response prediction is generated by the channel response prediction model based on at least a portion of information stored within the CSI buffer.

13. The UE of claim 11, wherein:
the processor is further configured to, in response to a determination that the mobility level of the UE exceeds the speed threshold, estimate a prediction factor; and
the future channel response prediction is generated by the channel response prediction model based on the prediction factor.

14. The UE of claim 13, wherein the prediction factor is estimated based on a speed of the UE and a variance of the speed of the UE.

15. The UE of claim 13, wherein a pilot density is temporarily increased, based on the estimated prediction factor.

16. The UE of claim 13, wherein:
the transceiver is configured to receive, from a base station (BS), an initial pilot or measurement report;
to generate the future channel response prediction, the processor is further configured to, for a number of iterations:
generate, with the channel response prediction model, an intermediate channel state prediction based on a pilot or measurement report most recently received by the transceiver; and
update a CSI buffer with the intermediate channel state prediction;
the number of iterations is based on the estimated prediction factor; and
the future channel response prediction is generated by the channel response prediction model based on at least a portion of information stored within the CSI buffer after the number of iterations.

17. The UE of claim 16, wherein the intermediate channel state prediction is an interpolation based on the pilot or measurement report most recently received by the transceiver and the estimated prediction factor.

18. The UE of claim 16, wherein:
the transceiver is further configured to receive, during the number of iterations, at least one subsequent pilot or measurement report; and
the processor is further configured to update the CSI buffer based on the at least one subsequent pilot or measurement report.

19. The UE of claim 11, wherein:
the processor is further configured to, in response to a determination that the mobility level of the UE exceeds the speed threshold, determine whether high-speed data is limited in a used data set or an available data set; and
the future channel response prediction is generated based on whether the high-speed data is limited in the used data set or the available data set.

20. The UE of claim 19, wherein:
to generate the future channel response prediction, the processor is further configured to, in response to a determination that the high-speed data is limited in the used data set or the available data set:
down-sample lower-speed data within the used data set or the available data set; and
update a data set based on the down-sampled lower-speed data, and
the future channel response prediction is generated based on the updated data set.
